(19) United States
(12) Patent Application Publication
(10) Pub. No.: US 2025/0220747 A1
(43) Pub. Date: Jul. 3, 2025

(54) MULTIPLE ACCESS SCHEME PROVISIONING

(71) Applicant: BRITISH TELECOMMUNICATIONS PUBLIC LIMITED COMPANY, LONDON (GB)

(72) Inventor: Farhad MEHRAN, London (GB)

(21) Appl. No.: 18/850,344

(22) PCT Filed: Feb. 10, 2023
(86) PCT No.: PCT/EP2023/053398

§ 371 Date: Sep. 24, 2024

(30) Foreign Application Priority Data
Mar. 24, 2022 (GB) 2204125.5

(51) Int. Cl. H04W 76/15; H04L 5/00

(52) U.S. Cl. CPC H04W 76/15; H04L 5/0037

(57) ABSTRACT

Examples exploit the processing capabilities of the available access points in a wireless telecommunications network operating in dual connectivity operation to enhance the data rate and fairness among the users. The wireless telecommunications network may include a first access point, or master node, connected to a plurality of further access points, or secondary nodes. The master node discovers which of the secondary access nodes has the processing capabilities and available processing capacity to handle NOMA transmissions. The master node can then coordinate the connection of a selected group of users to one of the secondary nodes that can support NOMA. The processing capabilities and available processing capacity to handle NOMA transmissions can be communicated by the secondary nodes to the master node actively, for example in a periodic manner, or reactively, for example as a result of a request for such information from the master node.

### CROSS-REFERENCE TO RELATED APPLICATIONS

The present application is a National Phase entry of PCT Application No. PCT/EP2023/053398, filed Feb. 10, 2023, which claims priority from GB Application No. 2204125.5, filed Mar. 24, 2022, each of which hereby fully incorporated herein by reference.

### TECHNICAL FIELD

This disclosure relates to the provisioning of a Non-Orthogonal Multiple Access scheme in a wireless telecommunications network.

### BACKGROUND

Wireless telecommunications networks use multiple access schemes to enable multiple users to simultaneously communicate with an access point. Most multiple access schemes work by allocating orthogonal resources (that is, resources that do not interfere with one another) to users, such as different time slots in Time Division Multiple Access (TDMA) or different frequencies in Frequency Division Multiple Access (FDMA). These are examples of Orthogonal Multiple-Access (OMA) schemes.

In contrast, Non-Orthogonal Multiple Access (NOMA) schemes have also been proposed, in which multiple users use the same resources concurrently. This can achieve improved data rates due to more availability of radio resources for allocating to the users compared with OMA schemes. NOMA schemes rely on the receiver implementing signal processing techniques to decode the required signal from multiple interfering signals transmitted by multiple users.

The different types of NOMA that have been proposed primarily fall into two categories: Code-Domain NOMA (CD-NOMA) and Power-Domain NOMA (PD-NOMA).

In 5^{th} Generation (5G) cellular systems and beyond, an increasingly large number of users require access to the radio channel. This is even more pronounced in massive machine-type communications (MTC), which are also known as IoT (Internet of Things) networks. MTCs are mostly uplink-centric, with sporadic transmission of small packets from a large number of users. Hence, significant research attention has been devoted to devising new techniques to allow a large number of users to gain access to the wireless channel. NOMA has attracted attention due to its capability to accommodate a large number of users by allowing them to share time/frequency radio resources between them, at the expense of additional signal processing.

“A Survey of Non-Orthogonal Multiple Access for 5G” by L. Dai et al., IEEE Communications Surveys & Tutorials (Volume: 20, Issue: 3, Third Quarter 2018, p2294-2323) explores the concept and advantages of NOMA techniques, as one of the promising technologies for future 5G systems. The dominant NOMA schemes are introduced together with a comparison in terms of their operating principles, key features, receiver complexity, pros and cons, etc. Highlighted are a range of key challenges, opportunities and future research trends related to the design of NOMA, including the theoretical analysis, the design of spreading sequences or codebooks, the receiver design, the design issues of access-grant-free NOMA, resource allocation schemes, extensions to massive MIMO systems and so on.

Since MTC and IoT networks are predominantly uplink focused in their data transmissions, NOMA can be employed as the additional processing required is incurred at the access point.

In PD-NOMA, downlink transmissions from an access point to each of a plurality of users are allocated different power levels based on each user's channel quality, such that a user with a higher quality channel is allocated a lower transmission power than a user with a lower quality channel. As the signals for the users are transmitted using the same resources, the user having a higher quality channel must subtract the signal for the user having a lower quality channel in order to detect their own signal. Existing channel estimation techniques can be used to determine the channel quality for each user when allocating the transmission power levels to each user. For uplink communications, each user transmits a signal to the access point, and the access point detects the signal from the user with the strongest received power and using interference cancellation techniques, it treats signals for other users as noise. The signal for the user having the second strongest received power is then detected using interference cancellation techniques by subtracting the signal for the strongest user and treating any signals for other users as noise. This iterative process continues until all signals for all users have been detected.

Furthermore, in cellular systems, Dual Connectivity (DC) enables a user to transmit/receive data simultaneously with two serving nodes or access points. This provides an increase in user throughput, provides mobility robustness, and supports load-balancing among nodes. For example, in E-UTRA-NR Dual Connectivity (EN-DC), both 4G and 5G connections are used to increase user throughput, utilizing the 5G spectrum while also providing users a 4G connection for wider coverage.

### SUMMARY

It is the aim of examples of the present disclosure to provide an improved method of provisioning a Non-Orthogonal Multiple Access scheme in a wireless telecommunications network, in particular in Dual Connectivity wireless telecommunications networks.

According to one example of the present disclosure, there is provided a method of managing a dual-connection from a user equipment to a first access point and one of a plurality of second access points in a wireless telecommunications network, wherein the user equipment is connected to the first access point, and the method comprises obtaining data indicating a non-orthogonal multiple access scheme capability for one or more of the second access points; determining which of the plurality of second access points supports a non-orthogonal multiple access scheme from the obtained data; selecting one of the determined second access points supporting a non-orthogonal multiple access scheme; and causing the user equipment to connect to the selected second access point using a non-orthogonal multiple access scheme.

The non-orthogonal multiple access scheme may be a power-domain non-orthogonal multiple access scheme. The non-orthogonal multiple access scheme may be for uplink traffic from the user equipment.

The user equipment may be connected to the first access point using an orthogonal multiple access scheme.

The user equipment may be connected to the first access point as a master node and connected to the second access point as a secondary node.

The data indicating a non-orthogonal multiple access scheme capability for one or more of the second access points may be obtained in response to a request for the data from the first access point.

The data indicating a non-orthogonal multiple access scheme capability for one or more of the second access points may be sent by one or more of the second access points when it has free non-orthogonal multiple access processing capacity.

The data indicating a non-orthogonal multiple access scheme capability for one or more of the second access points may be sent by one or more of the second access points periodically.

According to one example of the present disclosure, there is provided an access point for managing a dual-connection between a user equipment and the access point and one of a plurality of second access points in a wireless telecommunications network, wherein the user equipment is connected to the access point, and the access point is adapted in operation to: obtain data indicating a non-orthogonal multiple access scheme capability for one or more of the second access points; determine which of the plurality of second access points supports a non-orthogonal multiple access scheme from the obtained data; select one of the determined second access points supporting a non-orthogonal multiple access scheme; and cause the user equipment to connect to the selected second access point using a non-orthogonal multiple access scheme.

Thus, examples of the disclosure exploit the processing capabilities of the available access points in dual connectivity operation to enhance the data rate and fairness among the users. This is achieved by discovering the access points that have processing capabilities (and available processing capacity) to handle NOMA transmissions and subsequently, coordinate to connect a selected group of users to those access points.

### BRIEF DESCRIPTION OF THE DRAWINGS

For a better understanding of the present disclosure, reference will now be made by way of example only to the accompanying drawings, in which:

FIG. 1 is an example wireless telecommunications network.

FIG. 2 is a simplified diagram of an example master node.

FIG. 3 is a simplified diagram of an example secondary node.

FIG. 4 is a flow chart summarizing an example of the disclosure

FIG. 5 is a further flow diagram illustrating an example of the disclosure.

### DETAILED DESCRIPTION

The present disclosure is described herein with reference to particular examples. The disclosure is not, however, limited to such examples.

Examples of the disclosure exploit the processing capabilities of the available access points in a wireless telecommunications network operating in dual connectivity operation to enhance the data rate and fairness among the users. The wireless telecommunications network may include a first access point, or master node, connected to a plurality of further access points, or secondary nodes. The master node discovers which of the secondary access nodes has the processing capabilities and available processing capacity to handle NOMA transmissions. The master node can then coordinate the connection of a selected group of users to one of the secondary nodes that can support NOMA. The processing capabilities and available processing capacity to handle NOMA transmissions can be communicated by the secondary nodes to the master node actively, for example in a periodic manner, or reactively, for example as a result of a request for such information from the master node.

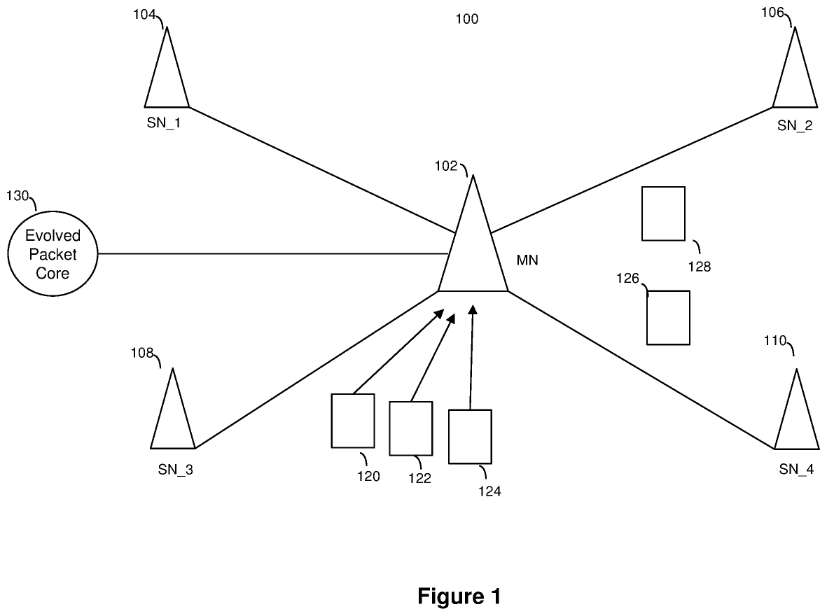

An example of a wireless telecommunications network of the present disclosure will now be described with reference to FIGS. 1. In this example, the wireless telecommunications network is a cellular telecommunications network 100 operating according to the 5th Generation (5G) protocol as standardized by the 3rd Generation Partnership Project (3GPP). The network 100 supports a Dual Connectivity DC architecture, or more specifically a EN-DC (E-UTRA and NR Dual Connectivity) architecture, where users are allowed to transmit and receive data simultaneously on two serving nodes: a master node (MN) and a secondary node (SN).

Network 100 comprises a master node (eNB) MN 102 connected to four secondary nodes (en-gNB) SNs-SN_1 104, SN_2 106, SN_3 108 and SN_4 110. The MN 102 is connected to a 4G core, an Evolved Packet Core EPC 130, and connected to each of the SNs via respective X2 interfaces. The MN 102 handles the control plane of the connected SNs, with the SNs only carrying user plane data. A plurality of user equipment (of respective users) are also shown: UE_1 120, UE_2 122, UE_3 124, UE_4 126 and UE 5 128. The user equipment UE are configured to communicate wirelessly with MN 102 or any of the SNs 104 to 110 using a suitable access scheme. The EPC 130 can send separate streams of user plane data directly to the MN 102 or the SNs for transmission onto connected UEs. Alternatively, the MN 102 can also split any data it receives from the EPC 130 for onward transmission itself to connected UEs, or via connected SNs. Likewise, SNs can split any data it receives from the EPC 130 for transmission itself to UEs or onto the MN 102.

The UE may be any suitably configured wireless device such as IoT devices/sensors, tablets, laptops or personal handsets.

Some of the nodes may have limited capacity for handling the intensive processing tasks required for facilitating NOMA, but some of the other nodes may be able to handle computationally-intensive operations for accommodating users via NOMA. Since one of the main bottleneck of adopting NOMA in data transmission scenarios on the uplink UL is the processing capacity of receiver (i.e. the nodes) in handling computationally-intensive tasks, examples of the disclosure can exploit the DC architecture to enable NOMA on some of the nodes and maintain OMA on the other nodes. This would meet the “fairness” targets between users and enhance the transmission rate.

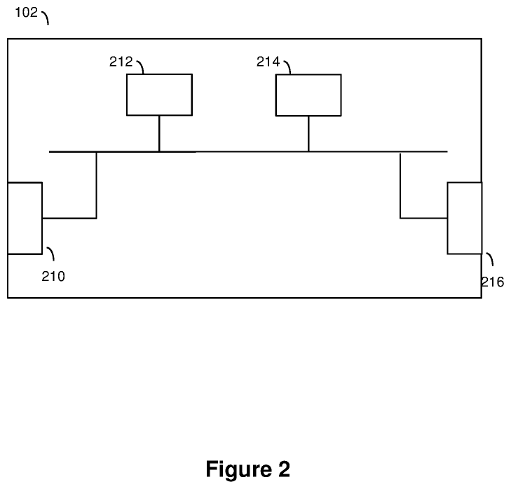

The MN 102 is shown in more detail in FIG. 2. The MN 102 comprises a first communication interface 210, processor 212, memory 214, and a second communications interface 216. The first communications interface 210 is configured for backhaul communications with the core network, and also for communications with the secondary nodes via X2 interfaces. The second communications interface 216 is configured for wireless communications with the user equipment using a suitable access scheme such as Non-Orthogonal Multiple Access (NOMA) scheme or Orthogonal Multiple Access (OMA) scheme. The processor 212 contains a processing module configured to enable examples of the disclosure as will be described below.

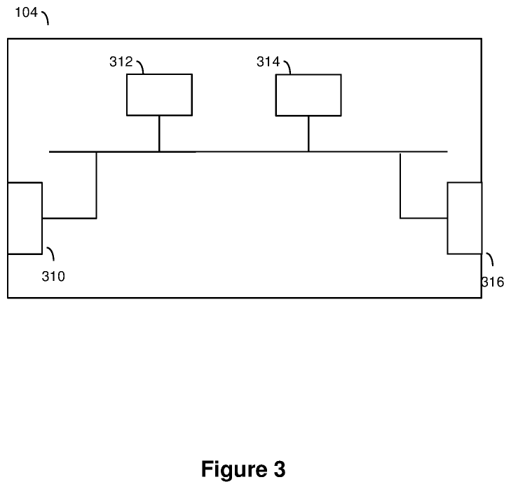

One of the secondary nodes, SN_1 104, is shown in more detail in FIG. 3. The other secondary nodes will contain similar elements. SN_1 104 comprises a first communication interface 310, processor 312, memory 314, and a second communications interface 316. The first communications interface 210 is configured for communications with the master node MN 102 via an X2 interface. The second communications interface 316 is configured for wireless communications with the user equipment using a suitable access scheme such as Non-Orthogonal Multiple Access (NOMA) scheme or Orthogonal Multiple Access (OMA) scheme. The processor 312 contains a processing module configured to enable examples of the disclosure as will be described below.

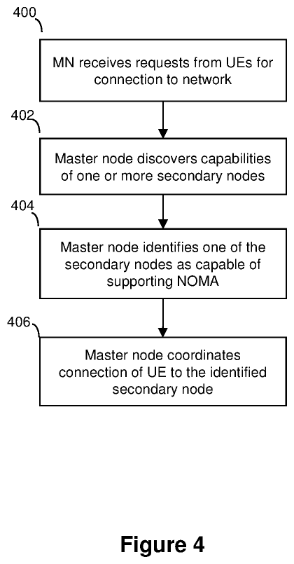

An example of the disclosure is summarized in the flow chart in FIG. 4, which is described with reference to the master node MN 102.

In this example, UE_1 120, UE_2 122, and UE_3 124 are already connected to MN 102 (using a OMA scheme), and UE_4 126 and UE_5 128 are new users to join the network.

Thus, processing begins at 400, where the MN 102 receives requests from UE 4 126 and UE_5 128 to connect to the network 100. The service to be provided for UE 4 126 and UE_5 128 requires high data rate which cannot be provided directly by the MN 102, as MN 102 in this example currently only supports OMA and its radio resources are currently limited. In this case, a NOMA scheme can significantly help to allow these UEs accessing the required radio resource. NOMA allows access to these radio resources even if they are in use by other UEs, as the access point can recover each UEs' signal by NOMA processing.

There can be various factors to consider that triggers use of other SN for incoming traffic, e.g., to provision fairness for users of the network. Put simply, if some of the SNs (and/or MN) are under heavy load of traffic that is being handled using NOMA, the connected users will suffer from large amounts of inter-user interference, hence it would be beneficial to hand over some of the NOMA-based connections to other nodes with relatively lower number of attached users. The result is that the amount of inter-user interference seen by users of each access point (whether SN or MN) can better reach a fair level (unlike having some users with severe inter-user interference and some users with minor inter-user interference). There are other circumstances as well that can trigger this process e.g. when the network load goes beyond a certain limit, to improve the spectral efficiency of the network, and to reserve capacity for incoming traffic, the communications based on OMA may be gradually moved to NOMA (when available).

Thus, at 402 MN 102 performs a node discovery process to determine whether any of the secondary nodes it is connected to can provide the required NOMA service. This can be done in various ways as will be described below, but in essence messages are exchanged between the MN 102 and the secondary nodes (SN_1 104, SN_2 106, SN_3 108 and SN_4 110) over the respective X2 interfaces, resulting in each the secondary nodes reporting data to the MN 102 detailing their respective NOMA processing capabilities.

At 404, the MN 102 uses the received data to identify one of the secondary nodes that can support NOMA. In this example, the identified secondary node is SN_4 110.

Then at 406, the MN 102 coordinates connection of the user equipment, UE_4 126 and UE_5 128, to SN_4 110, where the connection is supported by a NOMA scheme. The user equipment can then transmit data to SN_4 110, which in turn transmits it to the MN 102, and onto the core network. Whilst user plane data is sent to the network from UE_4126 and UE_5 128 via SN_4 110 using NOMA, control plane data continues to pass between the user equipment, UE_4 126 and UE_5 128, and the master node MN 102.

It should be noted that 400 and 402 may be performed in a reverse order, with the node discovery process at 402 being performed before the connection request at 400.

As stated above, the node discovery process can be performed in a number of ways. The main ways envisaged are a master node centric node discovery (MN-centric ND) process, and a secondary node centric node discovery (SN-centric ND) process.

In MN-centric ND, two sub-schemes are realized.

In the first MN-centric ND scheme (scheme 1), the MN 102 can send the required NOMA Processing Capacity (NPC) request messages (that collectively indicates the required set of resources and processing capabilities) to the SNs, and in response, the SNs respond with confirmation of whether they can support this request. The request from the MN 102 can be based on various factors such as forecasted demand of the user equipment wishing to connect, on current demand to meet fairness between users. In the second MN-centric ND scheme (scheme 2), the MN 102 asks the SNs for their available NPC and in response, the SNs declare their available NPCs. Thus, in scheme 1, the SNs give a answer of whether a specific set of NOMA requirements can be met or not. In contrast, in scheme 2, the SNs give a more detailed response of the specific level of resource that is available that could support NOMA. The advantage of scheme 2 is that if the NPC in SNs is not sufficiently high to handle the upcoming traffic, the MN 102 can still allow a selection of the SNs to support a portion of traffic (e.g., 1 out of the 2 UEs) depending on the NPCs.

In SN-centric ND, two sub-schemes are also realized.

In the first SN-centric ND scheme (scheme 1), whenever any of the SNs has free NPC, it declares it to MN 102 by sending an NPC update message. In the second SN-centric ND scheme (scheme 2), SNs will periodically declare their NPC to MN 102, by sending NPC update messages to MN 102 periodically.

Compared with the MN-centric ND schemes, the SN-centric ND schemes obviate the need for the MN 102 to send “NPC request” messages to the SNs. However, some of the NPC update messages that are sent might be redundant if a NOMA service is not required at that time. Furthermore, if the frequency of sending periodic update messages is too low, it may cause delays in providing a service to the users if such a service is needed.

As a result of node discovery (ND), the SN that can accommodate the request from the MN 102 will be chosen to support UE_4 126 and UE_5 128.

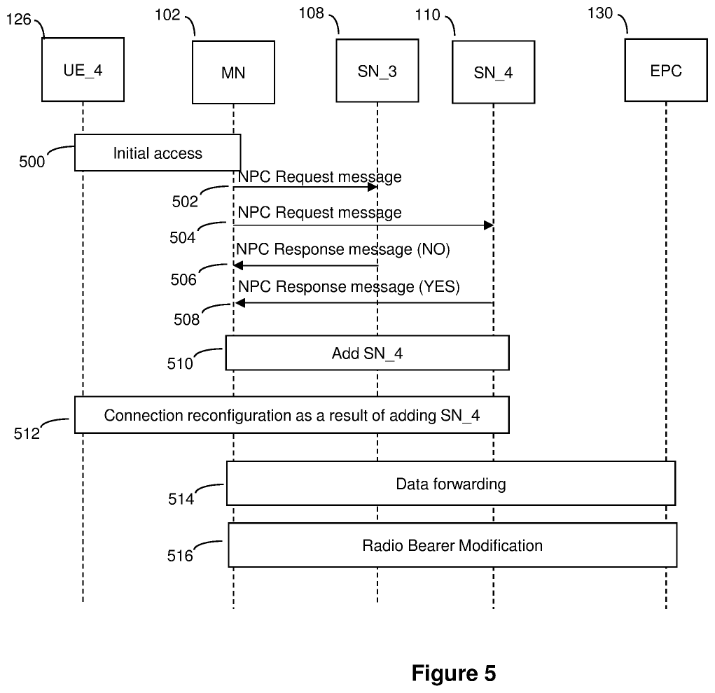

A more detailed description of an example of the node discovery and subsequent connection process now follows with reference to FIG. 5 and the first MN-centric ND scheme (scheme 1).

For simplicity, the number of elements involved in this example has been reduced, but the overall process remains the same. So here, there is one MN 102, two SNs, and a single new user equipment UE_4 126 requiring a NOMA connection.

Starting at 500, UE_4 126 initiates connection establishment with MN 102 by first finding and selecting this cell, and going through the Random Access procedure. MN 102 decides that a NOMA connection is required for UE_4 126, and is unable to provide such a connection directly, and so initiates (in this example) “MN-centric ND Scheme 1”.

At 502, MN 102 sends an NPC Request message to SN_3 108 and at 504 MN 102 also sends an NPC Request message to SN_4 110. These NPC Request messages detail the specific NOMA requirements needed. These request messages are effectively sent on demand in response to UE_4 128 initiating a connection request, as proposed under “MN-centric ND Scheme 1”.

At 506, SN_3 108 sends an NPC response (NO) message stating that the requested NOMA processing capabilities are not currently supported. Conversely, at 508, SN_4 110 sends an NPC response (YES) message stating that the requested NOMA processing capabilities are currently supported. Thus, the MN 102 identifies SN_4 110 as having the required NPC and thus capable of provided UE_4 126 with the required NOMA service.

At 510, MN 102 sends a request to SN_4 110 to add it as its secondary node, hence SN_4 110 is connected to MN 102 as a secondary node.

At 512, MN 102 sends a radio resource control reconfiguration message to the UE_4 126, which is followed by receiving completion message from UE_4 126 after UE_4 has applied the related reconfigurations. MN 102 then forwards this message to SN_4 to inform it that UE_4 126 has successfully applied the reconfigurations. UE_4 126 also performs Random Access procedure towards SN_4 110 at this stage, which can be before or after radio resource control reconfiguration completion.

Subsequently, depending on bearer characteristics (and if SN_4 110 bearers have moved from MN 102), MN 102 conducts data forwarding to minimize the service interruptions (at 514) and if applicable, the data path for user-plane towards the EPC 130 is updated (at 516)

Examples of the disclosure are realized, at least in part, by executable computer program code which may be embodied in an application program data. When such computer program code is loaded into the memory of the processor 212 in the master node 102, it provides a computer program code structure which is capable of performing at least part of the methods in accordance with the above described examples of the disclosure.

A person skilled in the art will appreciate that the computer program structure referred to can correspond to the flow chart shown in FIG. 4, where each operation of the flow chart can correspond to at least one line of computer program code and that such, in combination with the processor 212 in the master node 102, provides apparatus for effecting the described process.

In general, it is noted herein that while the above describes examples of the disclosure, there are several variations and modifications which may be made to the described examples without departing from the scope of the present disclosure as defined in the appended claims. One skilled in the art will recognize modifications to the described examples.

1. A method of managing a dual-connection from a user equipment to a first access point and one of a plurality of second access points in a wireless telecommunications network, wherein the user equipment is connected to the first access point, the method comprising:
obtaining data indicating a non-orthogonal multiple access (NOMA) scheme capability for one or more of the plurality of second access points;
determining which of the plurality of second access points supports the NOMA scheme from the obtained data;
selecting one of the determined second access points supporting the NOMA scheme; and
causing the user equipment to connect to the selected second access point using the NOMA scheme.

2. The method as claimed in claim 1, wherein the NOMA scheme is a power-domain NOMA scheme.

3. The method as claimed in claim 1, wherein the NOMA scheme is for uplink traffic.

4. The method as claimed in claim 1, wherein the user equipment is connected to the first access point using an orthogonal multiple access scheme.

5. The method as claimed in claim 1, wherein the user equipment is connected to the first access point as a master node and connects to the second access point as a secondary node.

6. The method as claimed in claim 1, where the data indicating the NOMA scheme capability for one or more of the plurality of second access points is obtained in response to a request for the data from the first access point.

7. The method as claimed in claim 1, where the data indicating the NOMA scheme capability for one or more of the plurality of second access points is sent by one or more of the second access points when the one or more second access points has free NOMA processing capacity.

8. The method as claimed in claim 1, where the data indicating the NOMA scheme capability for one or more of the plurality of second access points is sent by one or more of the second access points periodically.

9. An access point for managing a dual-connection between a user equipment and the access point and one of a plurality of second access points in a wireless telecommunications network, wherein the user equipment is connected to the access point, and the access point is adapted in operation to:
obtain data indicating a non-orthogonal multiple access (NOMA) scheme capability for one or more of the plurality of second access points;
determine which of the plurality of second access points supports the NOMA scheme from the obtained data;
select one of the determined second access points supporting the NOMA scheme;
cause the user equipment to connect to the selected second access point using the NOMA scheme.
